(19) United States
(12) Patent Application Publication
(10) Pub. No.: US 2023/0289171 A1
(43) Pub. Date: Sep. 14, 2023

(54) SYSTEM AND METHOD FOR UPDATING SOFTWARE ON A VEHICLE

(71) Applicant: TAIGA MOTORS INC., Lasalle (CA)

(72) Inventors: Mohannad ABDELAZIZ, Montreal (CA); Daniel LEBLANC, Montreal (CA); Simon LEMAY, North Vancouver (CA)

(21) Appl. No.: 18/111,989

(22) Filed: Feb. 21, 2023

Related U.S. Application Data
(60) Provisional application No. 63/317,994, filed on Mar. 9, 2022.

(51) Int. Cl. G06F 8/65; H04W 4/02; G06F 21/34; H04W 4/80

(52) U.S. Cl. CPC G06F 8/65; G06F 21/34; H04W 4/025; H04W 4/80

(57) ABSTRACT

Systems and methods for updating software on vehicles are provided. A method for performing a software update on a vehicle includes using a preference of a person of authority over the vehicle as to when to issue a request for an authorization to perform the software update on the vehicle. When the software update is available for the vehicle, the method includes issuing the request for the authorization to perform the software update on the vehicle in accordance with the preference of the person of authority over the vehicle. After receiving the authorization to perform the software update, the method includes initiating the software update on the vehicle.

### CROSS-REFERENCE TO RELATED APPLICATION AND CLAIM OF PRIORITY

The present application claims priority to U.S. Provisional Pat. Application Serial No. 63/317,994 filed on Mar. 9, 2022, the entire contents of which are hereby incorporated by reference.

### TECHNICAL FIELD

The disclosure relates generally to vehicles, and more particularly to updating software on off-road vehicles.

### BACKGROUND

Software is implemented in many products including vehicles. Software implemented into a product may require periodic updates over time to make corrections, improve performance, and/or to add or remove functionalities. Performing a software update on a vehicle can be time consuming and inconvenient since the vehicle may be temporarily out of order during the software update. Improvement is desirable.

### SUMMARY

In one aspect, the disclosure describes a method of performing a software update on a vehicle. The method comprises:
receiving a preference of a person of authority over the vehicle, the preference relating to issuing a request for an authorization to perform the software update on the vehicle;
determining that the software update is available for the vehicle;
issuing the request for the authorization to perform the software update on the vehicle in accordance with the preference of the person of authority over the vehicle;
receiving the authorization to perform the software update; and
initiating the software update on the vehicle after receiving the authorization to perform the software update.

The preference of the person of authority may include the request for the authorization to perform the software update on the vehicle to be issued only when the vehicle is located at one of one or more prescribed geographic locations.

The preference of the person of authority may include the request for the authorization to perform the software update on the vehicle to be issued only when the vehicle is operated by one of one or more prescribed operators.

The method may include receiving an identification of a current operator of the vehicle, and determining that the current operator is one of the one or more prescribed operators.

The method may include receiving the identification of the current operator via near-field communication.

The preference of the person of authority may be received via a portable electronic device separate from the vehicle.

The preference of the person of authority may be received via a user interface of the vehicle.

The request for the authorization to perform the software update on the vehicle may be issued via the portable electronic device separate from the vehicle.

The request for the authorization to perform the software update on the vehicle may be issued via the user interface of the vehicle.

The preference of the person of authority may include the request for the authorization to perform the software update on the vehicle to be issued only after the vehicle has been in an off state for a prescribed amount of time of at least 30 seconds.

The vehicle may be an electrically-propelled off-road vehicle. The initiation of the software update on the vehicle may be conditioned upon a state of charge of a motoring battery of the vehicle being greater than a prescribed state of charge.

Embodiments may include combinations of the above features.

In another aspect, the disclosure describes a computer program product for performing a software update on a vehicle, the computer program product comprising a non-transitory computer readable storage medium having program code embodied therewith, the program code readable/executable by a computer, processor or logic circuit to perform the method as defined in any one of claims 1 to 11.

In another aspect, the disclosure describes a system for performing a software update on a vehicle. The system comprises:
one or more data processors in data communication with a user interface; and
non-transitory machine-readable memory storing:
   a preference of a person of authority over the vehicle for issuing a request for an authorization to perform the software update on the vehicle, the preference including:
      the request for the authorization to perform the software update to be issued only when the vehicle is located at one of one or more prescribed geographic locations; and/or
      the request for the authorization to perform the software update to be issued only when the vehicle is operated by one of one or more prescribed operators; and
      instructions executable by the one or more data processors and configured to cause the one or more data processors to, when the software update is available for the vehicle:
         cause the request for the authorization to perform the software update on the vehicle to be issued via the user interface in accordance with the preference of the person of authority; and
         after receiving the authorization to perform the software update via the user interface, cause the software update to be performed on the vehicle.

The preference of the person of authority may include the request for the authorization to perform the software update on the vehicle to be issued only when the vehicle is located at one of one or more prescribed geographic locations.

The preference of the person of authority may include the request for the authorization to perform the software update on the vehicle to be issued only when the vehicle is operated by one of one or more prescribed operators.

The user interface may include a portable electronic device separate from the vehicle.

The user interface may include an instrument panel of the vehicle.

Embodiments may include combinations of the above features.

In another aspect, the disclosure describes a computer-implemented method for installing a new software version on an electric off-road vehicle. The method comprises:
causing a request for an authorization to install the new software version on the electric off-road vehicle to be issued via a user interface in accordance with a preference of a person of authority over the electric off-road vehicle, the preference including:
   the request for the authorization to install the new software version to be issued only when the electric off-road vehicle is located at one of one or more prescribed geographic locations; and/or
   the request for the authorization to install the new software version to be issued only when the electric off-road vehicle is operated by one of one or more prescribed operators;
   receiving the authorization to install the new software version; and
   causing the new software version to be installed on the electric off-road vehicle after receiving the authorization to install the new software version.

The user interface may include a portable electronic device separate from the electric off-road vehicle.

The user interface may include an instrument panel of the electric off-road vehicle.

The method may include causing the request for the authorization to install the new software version on the electric off-road vehicle to be issued only when a state of charge of a motoring battery of the electric off-road vehicle is greater than a prescribed state of charge.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a schematic representation of an exemplary electric off-road vehicle suitable for use with systems and methods described herein;

FIG. 2 shows an exemplary operator key and start button of the vehicle of FIG. 1;

FIG. 3 is a schematic illustration of a system for performing a software update on the electric off-road vehicle of FIG. 1;

FIG. 4 is a flow diagram of a method for performing a software update on a vehicle;

FIG. 5 is a data table including exemplary prompting preferences for requesting authorization to perform software updates on vehicles;

FIG. 6 is a schematic representation of an exemplary system for performing a software update on the vehicle of FIG. 1;

FIGS. 7A and 7B show examples of prompting preferences being specified on a user interface separate from the vehicle;

FIG. 7C shows an example of prompting preferences being specified using a user interface onboard the vehicle;

FIG. 8A shows an example of a prompt for authorizing a software update received via a user interface separate from the vehicle; and

FIG. 8B shows an example of a prompt for authorizing a software update received via a user interface onboard the vehicle.

### DETAILED DESCRIPTION

The present disclosure relates to systems and methods for facilitating software updates on (e.g., off-road) vehicles. In some embodiments, the methods and systems described herein may be particularly suitable for use with electric off-road (e.g., powersport) vehicles, but may be suitable for use with other types of (e.g., combustion engine) vehicles that may require a software update. In some embodiments, the methods and systems described herein may allow a person of authority over the vehicle to specify one or more preferences as to when a prompt requesting authorization to perform the software update on the vehicle will be issued. For example, such preferences may include an instruction to only issue the prompt when the vehicle is located at one of one or more prescribed geographic locations such as an operator’s home, an operator’s cottage, a vehicle storage facility, a vehicle rental facility, and/or a vehicle service facility for example. Alternatively or in addition, such preferences may include an instruction to only issue the prompt to one or more designated person(s) permitted to authorize the software update. For example, the prompt may be issued only when the vehicle is operated by one of one or more prescribed operators.

In some embodiments, the methods and systems described herein may reduce or eliminate nuisance prompts to perform software updates at inconvenient times, or prompts sent to an operator of the vehicle not permitted to authorize the software update. In some embodiments, the methods and systems described herein may facilitate the authorization to perform the software update to be provided by a designated person, and also promote the installation of the software update when it is convenient and safe to do so (e.g., not when an off-road vehicle and its operator are in a remote location, in inclement weather, have limited fuel or battery capacity, and/or have limited or expensive internet connectivity).

Aspects of various embodiments are described through reference to the drawings.

The term “connected” may include both direct connection (where two elements contact each other) and indirect connection (where at least one additional element is located between the two elements).

The term “substantially” as used herein may be applied to modify any quantitative representation which could permissibly vary without resulting in a change in the basic function to which it is related.

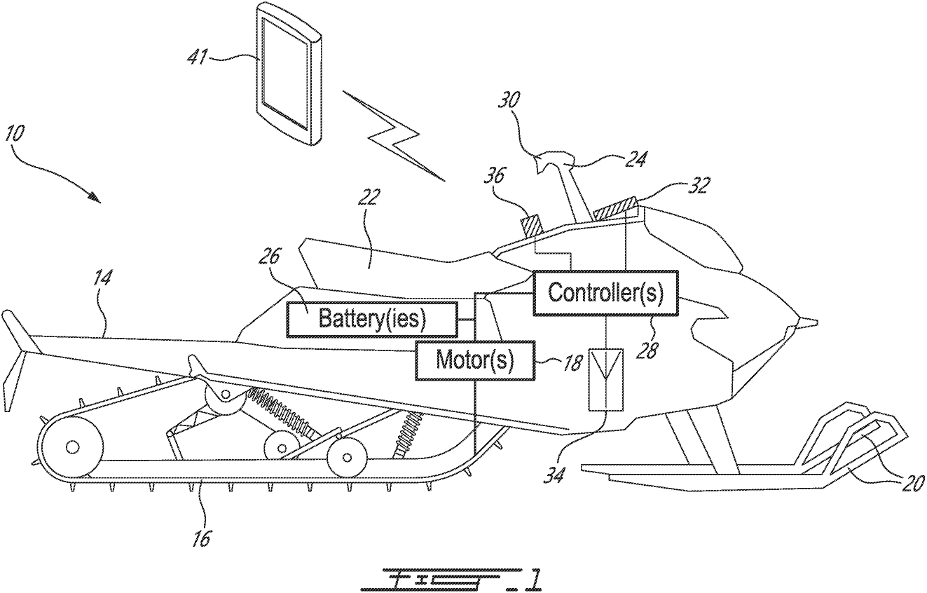

FIG. 1 is a schematic representation of an exemplary electric off-road vehicle 10 (referred hereinafter as “vehicle 10”), which may be suitable for use with the systems and methods described herein. As illustrated in FIG. 1, vehicle 10 may be a snowmobile but it is understood that the systems and methods described herein may also be used with other types of off-road vehicles including (e.g., electric) utility task vehicles (UTVs), such as side-by-side vehicles, (e.g., electric) all-terrain vehicles (ATVs), and (e.g., electric) personal watercraft (PWC) for example. In some embodiments, vehicle 10 may be an electric snowmobile including elements of the snow vehicle described in International Patent Application no. WO 2019/049109 A1 (Title: Battery arrangement for electric snow vehicles), and U.S. Pat. Application no. 63/135,497 (Title: Electric vehicle with battery pack as structural element) which are incorporated herein by reference.

Vehicle 10 may include a frame (also known as a chassis) which may include tunnel 14, a track 16 having the form of an endless belt for engaging the ground and disposed under tunnel 14, and one or more electric motors 18 (referred hereinafter in as “motor 18”) mounted to the frame and configured to drive track 16. Vehicle 10 may include left and right skis 20 disposed in a front portion of vehicle 10, straddle seat 22 disposed above tunnel 14 for accommodating an operator of vehicle 10 and optionally one or more passengers. Skis 20 may be movably connected to the frame to permit steering of vehicle 10 via a steering assembly including a steering column interconnecting handlebar 24 with skis 20.

Motor 18 may be drivingly connected to track 16 via a drive shaft to cause propulsion of vehicle 10. Motor 18 may be in torque-transmitting engagement with the drive shaft via a belt/pulley drive. However, motor 18 may be in torque-transmitting engagement with the drive shaft via other arrangements such as a chain/sprocket drive, or shaft/gear drive for example. The drive shaft may be drivingly connected to track 16 via one or more toothed wheels or other means so as to transfer motive power from motor 18 to track 16.

Vehicle 10 may also include one or more (e.g., high-voltage) batteries 26 (referred hereinafter in the singular as “battery 26”) for providing electric power to motor 18 and driving motor 18. Battery 26 may be a main battery pack used for propelling vehicle 10, and may be referred to as a motoring battery. Battery 26 may be disposed under seat 22. The operation of motor 18 may be controlled by one or more controllers 28 (referred hereinafter in the singular) based on an actuation of accelerator 30, also referred to as “throttle”, by the operator. In some embodiments, battery 26 may be a rechargeable lithium ion or other type of battery. In some embodiments, battery 26 may be configured to output electric power at a voltage of between 300-400 volts, or up to 800 volts, for example.

Vehicle 10 may include onboard user interface 32, which may be in the form of an instrument panel, including handlebar button clusters, and/or one or more operator input devices (e.g., accelerator 30 and start button 42) permitting the operator to input commands or other data into vehicle 10, and also receive information about vehicle 10. Onboard user interface 32 may include one or more devices for manipulation by the operator. Such devices may, for example, include rotary switches, toggle switches, push buttons, knobs, dials, etc. The operator input devices may include one or more physical (hard) devices and/or one or more graphical objects on a graphical interface provided on a display screen for example. Onboard user interface 32 may include a liquid crystal display (LCD) screen, thin-film-transistor (TFT) LCD screen, light-emitting diode (LED) or other suitable display device operatively connected to controller 28. In some embodiments, onboard user interface 32 may be touch-sensitive to facilitate operator inputs. As explained further below, onboard user interface 32 may be capable of being controlled by controller 28 to selectively prompt the operator with a request for the authorization to perform a (e.g., over-the-air) software update on vehicle 10 in accordance with one or more preferences of a person of authority over vehicle 10. Such person of authority over vehicle 10 may be an operator (rider) of vehicle 10, an owner of vehicle 10, a custodian of vehicle 10, a fleet manager, or service personnel for example.

Vehicle 10 may include onboard antenna 34 operatively connected to a wireless transceiver and controller 28 to permit wireless over-the-air receipt and transmission of data to and from vehicle 10. Alternatively, or in addition, vehicle 10 may include physical data port (e.g., Universal Serial Bus (USB)) to permit wired data communication (e.g., receipt and transmission) with a portable electronic device (e.g., smartphone, laptop computer, tablet computer) or other data storage device (e.g., USB flash drive). Antenna 34 and/or other physical data port(s) may permit a data package including a new software version to be downloaded to vehicle 10 either wirelessly (over-the-air) or by wired data communication prior to or when performing a software update on vehicle 10 for example.

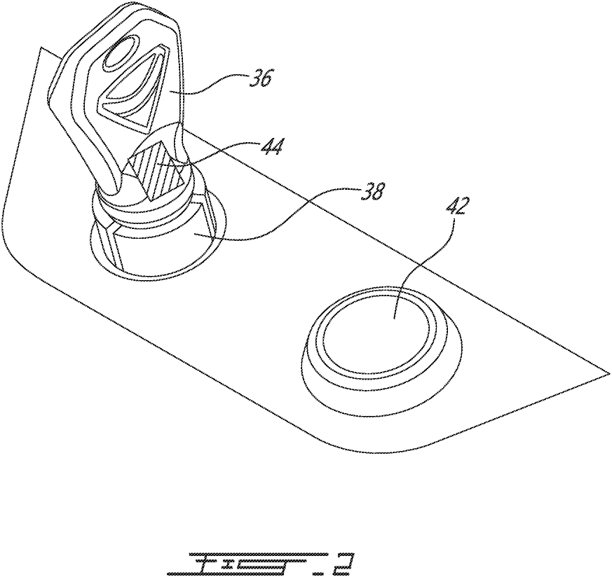

In some embodiments, operator key 36 may permit the operation of vehicle 10 when key 36 is received into receptacle 38 (shown in FIG. 2) of vehicle 10, or when key 36 is in sufficient proximity to vehicle 10 for example. The engagement of key 36 with receptacle 40 or the proximity of key 36 to vehicle 10 may be communicated to controller 28 to authorize the activation and/or operation of vehicle 10. Key 36 may be attached to one end of a tether (e.g., lanyard) where the opposite end of the tether may be attached to the operator’s clothing, belt, or (e.g., for watercraft use) personal flotation device during operation of vehicle 10. In some embodiments, key 36 may be used to provide an identification of the operator or type of operator operating vehicle 10. For example, key 36 may be identifiable as an owner’s key, another rider’s key, a fleet manager’s key, or the key of service personnel for example.

Alternatively or in addition to the use of key 36, the presence and identity of the operator in proximity to vehicle 10 and/or the authorization of the operator to operate vehicle 10 may be established by detecting and communicating with a portable electronic device 41 (referred hereinafter as “PED 41”) such as a smartphone that may be carried by the operator. Such PED 41 may be in wireless data communication (e.g., paired via Bluetooth®) with controller 28 to inform controller 28 of the proximity of the operator via the PED 41 as a proxy. The proximity of PED 41 from vehicle 10 may be used to provide an identification of the operator operating vehicle 10. Alternatively or in addition, the operator’s authorization to operate vehicle 10, and/or the identification of the operator may be established by way of an authorization code or password that may be manually entered by the operator via an instrument panel of vehicle 10, or via PED 41 in communication with vehicle 10, permitting the operator to interact with and provide inputs to vehicle 10. The identification of the operator may be used by the systems and methods described herein to determine whether or not the current operator of vehicle 10 may be prompted to authorize a software update.

FIG. 2 shows an exemplary operator key 36 and start button 42 of vehicle 10. In some embodiments, key 36 or other device (e.g., PED 41) may be in communication with vehicle 10 via a suitable near-field communication (NFC) protocol to provide contactless identification of the operator. For example, key 36 may be part of a radio-frequency identification (RFID) system of vehicle 10. Key 36 may include RFID tag 44 which may store data identifying key 36 and/or a specific operator associated with key 36. When triggered by an electromagnetic interrogation pulse from a RFID reader device associated with vehicle 10, RFID tag 44 may wirelessly transmit the data stored on RFID tag 44 and the data may be used by controller 28 to authenticate key 36 and either permit or prevent the operation of vehicle 10 based on the data. In some embodiments, key 36 may interact with a software-based or physical/mechanical hardware-based switch disposed within receptacle 38 so that the insertion and withdrawal of key 36 into and out of receptacle 38 may cause key 36 to interface with and actuate such switch, and signal to controller 28 the operator’s authorization to use vehicle 10. In some embodiments, vehicle 10 may include a (e.g., rotary) switch that is actuatable with key 36.

Start button 42 may be disposed in proximity to receptacle 38. Start button 42 may be operatively connected to controller 28 to generate one or more vehicle activation commands to cause vehicle 10 to transition from an inactive (off) state to an intermediate wake state and/or to an active (on) state for example. Vehicle 10 may include (e.g., emergency) shutoff switch, sometimes referred to as a “kill switch”, operatively connected to controller 28 to cause vehicle 10 to transition from the active state to the intermediate wake state and/or to the inactive state for example.

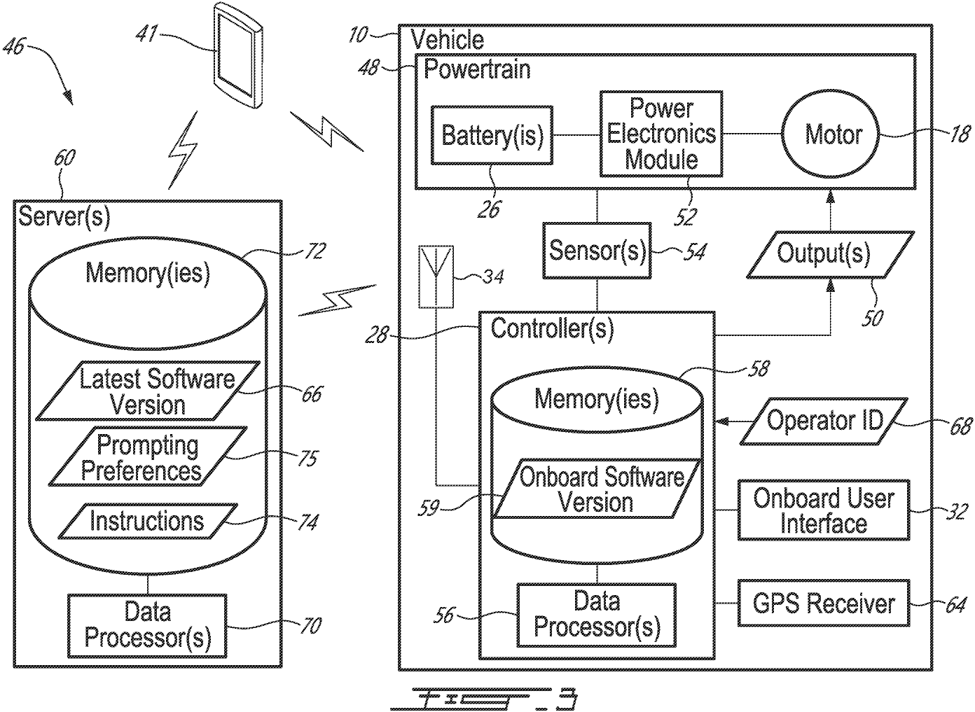

In the inactive (off) state, controller 28, user interface 32 and other devices/accessories of vehicle 10 may be turned off and not supplied with power. The intermediate wake state may be a partially active state that enables some systems of vehicle 10, such as turning on a display of vehicle 10, but may restrict (e.g., prevent) the use of accelerator 30 to deliver power to motor 18 and propel vehicle 10. For example, an operator may interact with onboard user interface 32 of vehicle 10 to select an operation mode (e.g., economy, normal, sport) for vehicle 10 and/or adjust other vehicle settings. In the intermediate wake state, one or more preparatory tasks may be carried out in preparation for the driving of vehicle 10 but propulsion of vehicle 10 via motor 18 may be prevented. Transitioning vehicle 10 from the inactive state to the intermediate wake state may include electrically connecting battery 26 to power electronics module 52 (shown in FIG. 3) such as an inverter operatively connected to control a delivery of electric power from battery 26 to motor 18. The fully active (on) state may enable all systems of vehicle 10, including the activation of one or more displays, and the use of accelerator 30 to deliver power to motor 18 and propel vehicle 10. The active state of vehicle 10 may also be referred to as an “in gear” state.

FIG. 3 is a schematic illustration of a system for performing (e.g., over-the-air) software updates on vehicle 10. FIG. 3 also shows another schematic representation of vehicle 10. Motor 18 may provide propulsive power to vehicle 10 and may be part of powertrain 48 of vehicle 10. In various embodiments, motor 18 may be a permanent magnet synchronous motor or a brushless direct current motor for example. Motor 18 may be of a same type as, or may include elements of, the motors described in U.S. Provisional Pat. Applications no. U.S. 63/135,466 (Title: Drive unit for electric vehicle) and no. U.S. 63/135,474 (Title: Drive unit with fluid pathways for electric vehicle), which are incorporated herein by reference.

Motor 18 may be drivingly connected to track 16 (shown in FIG. 1) in embodiments where vehicle 10 is a snowmobile for example. For UTVs and ATVs, motor 18 may be drivingly connected to ground-engaging wheels. For PWCs, motor 18 may be drivingly connected to an impeller for example. Powertrain 48 may also include battery 26 for providing electric power to motor 18. The operation of motor 18 and the delivery of electric power to motor 18 may be controlled by controller 28 via output(s) 50 and power electronics module 52. Power electronics module 52 may include suitable electronic switches (e.g., insulated gate bipolar transistor(s)) to provide motor 18 with electric power having the desired voltage, current, waveform, etc. to implement the desired performance of vehicle 10 based on an actuation of accelerator 30 by the operator to indicate a command to propel vehicle 10A. In some embodiments, power electronics module 52 may include a power inverter for example.

Vehicle 10 may include one or more sensors 54 operatively connected to component(s) of powertrain 48. Sensor(s) 54 may be configured to sense one or more parameters of powertrain 48. Controller 28 may be configured to control motor 18 based on feedback received via sensor(s) 54. Controller 28 may include one or more data processors 56 (referred hereinafter as “processor 56”) and non-transitory machine-readable memory 58. Controller 28 may be operatively connected to sensor(s) 54 via wired or wireless connections for example so that one or more parameters acquired via sensor(s) 54 may be received at controller 28 and used by processor 44 in one or more procedures or steps defined by machine-readable instructions stored in memory 58 and executable by processor 56. For illustration, the instructions stored in memory 58 are identified as onboard software version 59 which may be in need of being updated in view of latest software version 66 being available.

Controller 28 may carry out additional functions than those described herein. Processor 56 may include any suitable device(s) configured to cause a series of steps to be performed by controller 28 so as to implement a computer-implemented process such that the instructions in onboard software version 59, when executed by controller 28 or other programmable apparatus, may cause the functions/acts to be executed. Processor 56 may include, for example, any type of general-purpose microprocessor or microcontroller, a digital signal processing (DSP) processor, an integrated circuit, a field programmable gate array (FPGA), a reconfigurable processor, other suitably programmed or programmable logic circuits, or any combination thereof.

Memory 58 may include any suitable machine-readable storage medium. Memory 58 may include non-transitory computer readable storage medium such as, for example, but not limited to, an electronic, magnetic, optical, electromagnetic, infrared, or semiconductor system, apparatus, or device, or any suitable combination of the foregoing. Memory 58 may include a suitable combination of any type of machine-readable memory that is located either internally or externally to controller 28. Memory 58 may include any storage means (e.g. devices) suitable for retrievably storing machine-readable instructions executable by processor 56.

Sensor(s) 54 may include one or more current sensors and/or one or more voltage sensors operatively connected to battery 26 and/or operatively connected to power electronics module 52. Sensor(s) 54 may acquire one or more signals indicative of, or useful in deriving, a state of charge (SoC) of battery 26 and/or other parameters of powertrain 48. The SoC may be expressed as a percentage of the capacity of battery 26 (e.g., 0% = empty; 100% = full), or as any other suitable indication.

Vehicle 10 may be capable of data communication with one or more devices such as PED 41 and server 60 external to vehicle 10. Vehicle 10 may include one or more wireless transceivers operatively connected to controller 28 to enable receipt and transmission of data to and from vehicle 10 via onboard antenna 34. The wireless transceiver may be configured for wireless data communication at one or more frequencies (e.g., 915 MHZ and/or at 2.4 GHz).

Vehicle 10 may include a satellite navigation device, referred herein as a global positioning system (GPS) receiver 64, operatively connected to controller 28. GPS receiver 64 may be capable of receiving information from global navigation satellite systems (GNSS) satellites that may be used to calculate a geographical position of vehicle 10. For example, GPS receiver 64 may be used to determine whether vehicle 10 is at one of one or more prescribed geographic locations suitable for issuing a prompt to request authorization to perform a (e.g., over-the-air) software update to replace onboard software version 59 with latest software version 66 available on server 60.

Controller 28 of vehicle 10 may also receive or determine operator ID 68 of the operator currently operating vehicle 10, via key 36 and/or PED 41 as explained above, or by other suitable means.

FIG. 3 is also shows a schematic representation of server 60 of system 46. Server 60 may include a computer configured for data communication with other elements of system 46 via one or more suitable antennae for example. Server 60 may include one or more computing devices and one or more data storage and retrieval devices. Server 60 may be configured for cloud computing to deliver hosted services over the internet. For example, server 60 may include data processor 70 operatively connected to memory 72. Processor 70 may include any suitable device(s) (as disclosed herein or of other type) configured to cause a series of steps to be performed by server 60 so as to implement a computer-implemented process such that machine-readable instructions 74, when executed by server 60 or other programmable apparatus, may cause the functions/acts specified in the methods described herein to be executed. Memory 72 may include suitable non-transitory computer readable storage medium (e.g. devices) suitable for retrievably storing machine-readable instructions 74 executable by processor 70.

Server 60 may store latest software version 66 available for vehicle 10 and facilitate the (e.g., over-the-air) software update to replace onboard software version 59 currently installed on vehicle 10 with latest software version 66 available. Server 60 may facilitate the software update according to prompting preferences 75 stored in memory 72 of server 60 or otherwise available to server 60. Alternatively, controller 28 may store latest software version 66 available for vehicle 10 and facilitate the software update according to prompting preferences 75 stored in memory 58 of controller 28 or otherwise available to controller 28. For example, server 60 or controller 28 of vehicle 10 may determine when to issue the prompt to request authorization to perform the software update based on prompting preferences 75.

Various aspects of the present disclosure may be embodied as systems, devices, methods and/or computer program products. Accordingly, aspects of the present disclosure may take the form of an entirely hardware embodiment, an entirely software embodiment or an embodiment combining software and hardware aspects. Furthermore, aspects of the present disclosure may take the form of a computer program product embodied in one or more non-transitory computer readable medium(ia) (e.g., memory 58, 72) having computer readable program code (e.g., instructions 74, 59, 66) embodied thereon. Computer program code for carrying out operations for aspects of the present disclosure in accordance with instructions 74, 59, 66 may be written in any combination of one or more programming languages. Such program code may be executed entirely or in part by controller 28 and/or server 60 or other data processing device(s). Based on the present disclosure, one skilled in the relevant arts could readily write computer program code for implementing the methods described and illustrated herein.

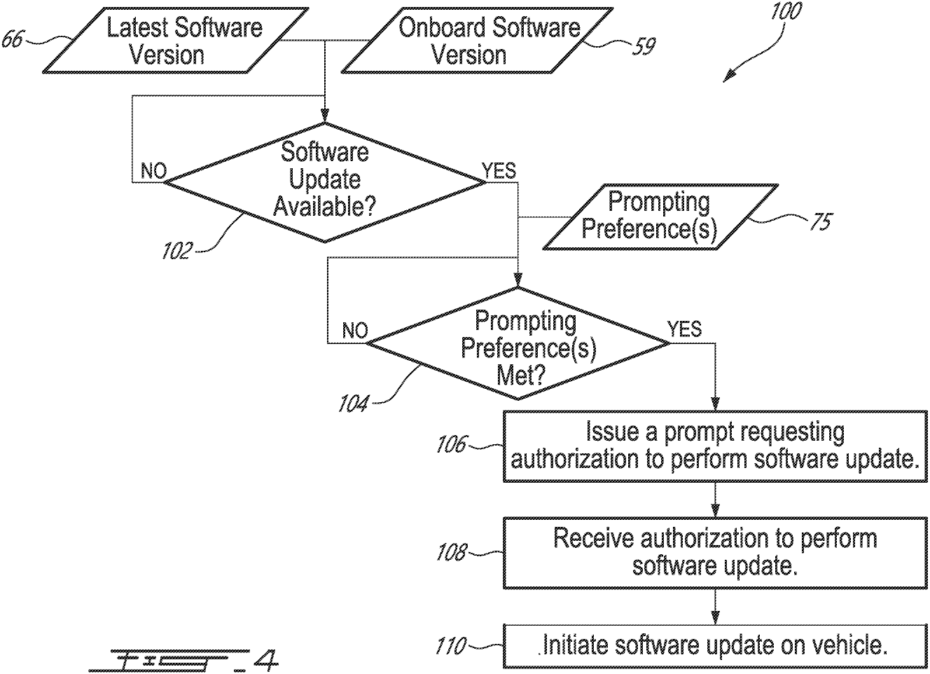

FIG. 4 is a flow diagram of method 100 for performing a software update on vehicle 10 or on another vehicle. Method 100 may include other actions disclosed herein or may be combined with other methods or steps. In various embodiments, method 100 may be carried out using elements of system 46. In some embodiments, method 100 may be partially or entirely performed by server 60. In some embodiments, method 100 may be partially or entirely performed by controller 28 of vehicle 10. In some embodiments, part of method 100 may be performed by server 60 and part of method 100 may be performed by vehicle 10. Functions and other aspects of vehicle 10 and of system 46 may be incorporated into method 100. Further aspects of method 100 are described below in reference to other figures. In various embodiments, method 100 may be computer-implemented and may include:
receiving one or more prompting preferences 75 of a person of authority over vehicle 10, the prompting preferences 75 relating to (e.g., the timing of, the circumstances of) an issuance of a request for an authorization to perform the software update on vehicle 10;
determining that the software update is available for the vehicle 10 (block 102);
issuing the request for the authorization to perform the software update on vehicle 10 in accordance with prompting preferences 75 of the person of authority over vehicle 10 (block 106);
receiving the authorization to perform the software update (block 108); and
initiating the software update on vehicle 10 after receiving the authorization to perform the software update (block 110).

At decision block 102, method 100 may include determining whether a software update is available for vehicle 10. This may be done by detecting a mismatch between onboard software version 59 and latest software version 66, or by a recent availability of latest software version 66. In the event that a software update is not available, method 100 may end. The verification of whether a software update is available may be performed periodically. Alternatively or in addition, controller 28 of vehicle 10 may receive a push notification (e.g., from server 60) when latest software version 66 is available.

At decision block 104, method 100 may include determining whether the prompting reference has been met before issuing the prompt requesting authorization of the software update to the operator or another designated person. When a software update is determined to be available at block 102, method 100 may periodically check for the next opportunity at which the prompting preference(s) 75 is/are met to issue the prompt requesting for authorization at the earliest opportunity. After receiving the authorization to perform the software update, the software update may be initiated on vehicle 10.

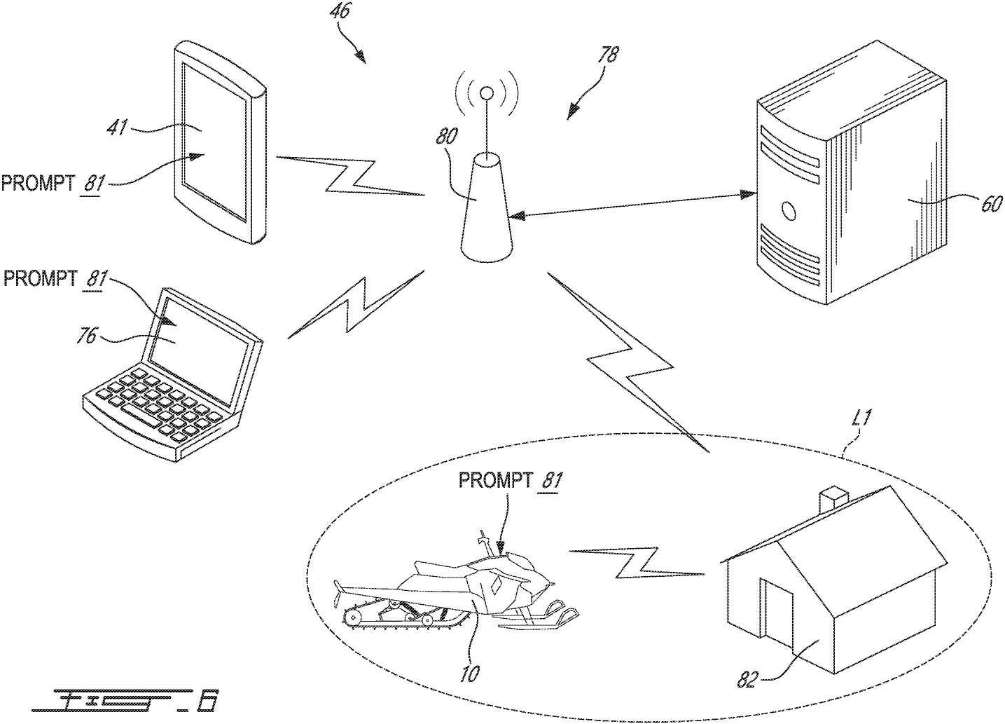

The software update may be initiated by way of server 60 sending an initiation command to vehicle 10 to instruct controller 28 to start installing latest software version 66. Alternatively, the determination to initiate the software update may be made onboard vehicle 10. In some embodiments, a data (i.e., software) package including latest software version 66 may have already been downloaded onto vehicle 10 by the time the prompt is issued and the software update is initiated. For example, the data package may be downloaded onto controller 28 (pushed to vehicle 10) as soon as it is ready. Alternatively, the data package may be downloaded to controller 28 only when a reliable and affordable internet connection is available to vehicle 10. In some embodiments, the prompt requesting authorization to install latest software version 66 may be issued only after the data package has been partially or entirely downloaded onto controller 28. Server 60 or controller 28 may manage the prompting of the person of authority. The prompt may be provided via onboard user interface 32, or server 60 or controller 28 may provide the prompt to PED 41 or laptop computer 76 (shown in FIG. 6) wirelessly via Bluetooth® or LTE for example.

In some embodiments, the initiation of the software update may trigger an over-the-air download of the data package onto vehicle 10 followed by the installation of latest software version 66 onto vehicle 10. Antenna 34 and/or other physical data port(s) may permit the data package including to be downloaded to vehicle 10 either wirelessly (over-the-air) or by wired data communication prior to or when performing a software update on vehicle 10 for example. The data package may be downloaded onto vehicle 10 in a single shot or in multiple installments.

During the software update, vehicle 10 may be in the wake state where controller 28 is powered and performing the software update but vehicle 10 is not drivable. If vehicle 10 is in the off state when the software update is initiated, vehicle 10 may need to be transitioned to the wake state to perform the software update. For example, the initiation command sent from server 60 may be configured to cause vehicle 10 to transition from the off state to the wake state. For example, the initiation command may cause an action equivalent to pressing start button 42 once to transition vehicle 10 from the off state to the wake state. After the completion of the software update, vehicle 10 may be transitioned from the wake state to the off state.

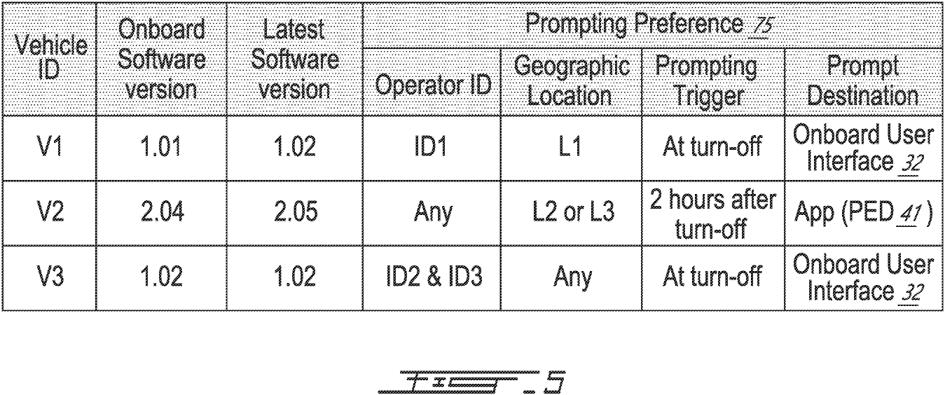

FIG. 5 is a data table including exemplary prompting preferences 75 for requesting authorization to perform software updates on a plurality of vehicles. Prompting preferences 75 may be stored on server 60 and may include latest software versions, onboard software versions, and prompting preferences 75 associated with a plurality of vehicles. For example, the data table may be stored in a database used by server 60 to facilitate software updates on some or all vehicles of a manufacturer, or of a fleet of vehicles of a vehicle rental agency for example. In some embodiments, prompting preferences 75 associated with a single vehicle 10 may be stored locally on that vehicle 10 and used by controller 28 to manage the prompting for authorization to perform the software update.

The vehicle identifications (IDs) may be associated with prompting preferences 75 that are provided by a person of authority over the respective vehicle IDs V1, V2, V3. Vehicle IDs V1, V2, V3 may be serial numbers or other identification characters. Prompting preferences 75 may include prescribed operator IDs ID1, ID2, ID3 that represent designated vehicle operators to whom the prompt requesting authorization to perform the software update may be issued when the prompt is issued via onboard user interface 32 for example. As explained above operator IDs ID1, ID2, ID3 may be determined onboard vehicle 10 by way of key 36, PED 41, or other (e.g., contactless, NFC) suitable identification means for example. Prescribed operator IDs ID1, ID2, ID3 may have been previously determined to be permitted to authorize software updates. For example, operator IDs ID1 and ID2 may represent respective owners associated with vehicle IDs V1 and V3. For example, operator ID3 may represent service personnel or a custodian associated with vehicle ID V3. Prompting preferences 75 for vehicle ID V1 may include the prompt requesting authorization to perform the software update to be issued only when vehicle 10 having vehicle ID V1 is operated by the operator associated with operator ID ID1. Prompting preferences 75 for vehicle ID V3 may include the prompt requesting authorization to perform the software update to be issued only when vehicle 10 having vehicle ID V3 is operated by the operators associated with operator IDs ID2 and ID3. In other words, the prompt may not be issued when the respective vehicles are operated by other operators not included in prompting preferences 75.

Prompting preferences 75 may include one or more prescribed geographic locations L1, L2, L3 at which vehicle 10 must be located so that the prompt requesting authorization to do the software update be issued. Geographic locations L1, L2, L3 may be predetermined GPS coordinates (e.g., associated with an address) that can be verified against the actual location of vehicle 10 by way of GPS receiver 64. Geographic locations L1, L2, L3 may be specific locations or regions within which vehicle 10 must be located. For example, geographic locations L1, L2, L3 may each include GPS coordinates in conjunction with a tolerance (radius) defining a region. In another example, geographic locations L1, L2, L3 may each include GPS coordinates located within a selected geofence (i.e., virtual fence or perimeter around a physical location). The geofence may be defined by the person of authority over vehicle 10 via suitable mapping software for example. Suitable geographic locations L1, L2, L3 may include a vehicle owner’s home or cottage, a vehicle operator’s home or cottage, a vehicle service facility, a vehicle storage facility, or another location deemed safe and appropriate to perform the software update. For example, geographic locations L1, L2, L3 may provide a reliable and affordable internet (e.g., Wi-Fi or cellular) connection available to vehicle 10 for performing an over-the-air software update. Prompting preferences 75 for vehicle ID V1 may include the prompt requesting authorization to perform the software update on vehicle 10 having vehicle ID V1 to be issued only when vehicle 10 having vehicle ID V1 is located at prescribed geographic location L1. Prompting preferences 75 for vehicle ID V2 may include the prompt requesting authorization to perform the software update on vehicle 10 having vehicle ID V2 to be issued only when vehicle 10 having vehicle ID V2 is located at one of prescribed geographic locations L2 and L3. In other words, the prompt may not be issued when the respective vehicles are not at the prescribed geographic locations.

Prompting preferences 75 may include one or more other prompting triggers for the prompt requesting authorization to do the software update to be issued. Such prompting triggers may include vehicle 10 just having been turned off, or having been turned off for a prescribed amount of time. In various embodiments, such prescribed amount of time may be 30 seconds or longer, 10 minutes or longer, or between 1 and 4 hours for example. The turning off of vehicle 10 may indicate an upcoming period of inactivity of vehicle during which it may be convenient to perform the software update. Other prompting preferences 75 may include a desired time of day to receive a prompt. For example, a prompting trigger may include a time of day during which a prompt may be issued. In some examples, an operator may prefer to receive a prompt requesting authorization to do the software update between 6:00 pm and 10:00 pm if it is less likely that the operator will use vehicle 10 during that time window. Other prompting triggers may include a health or operating state of vehicle 10, a SoC of battery 26, or whether vehicle 10 is connected to a power source for recharging battery 26. For example a minimum SoC of battery 26 may be required to complete the software update. Accordingly, prompting preferences 75 may include a condition of SoC of battery 26 being greater than a prescribed SoC in order to issue the prompt.

Prompting preferences 75 may include preferences for prompt destinations for issuing the prompt requesting authorization to do the software update. For example, a preference may be to have the prompt issued to onboard user interface 32 to have a current operator of vehicle 10 provide the authorization. Alternatively or in addition, a preference may be to have the prompt issued to an application (app) installed on laptop computer 76 (shown in FIG. 6) or on PED 41 associated with a designated person permitted to authorize the software update, such as a fleet manager for example.

FIG. 6 is another schematic representation of system 46 for facilitating software updates on vehicle 10. FIG. 6 shows prompt 81 requesting authorization to do the software update being provided on onboard user interface 32 of vehicle 10, via PED 41, and/or via laptop computer 76. Server 60 may be in data communication with vehicle 10, PED 41 and/or laptop computer 76 via communication network 78. Network 78 may include one or more network antennas 80. Network 78 may include a local area network (LAN), wide area network (WAN), cellular (e.g., 4G or Long-Term Evolution (LTE)) network, internet-based network, satellite-based network, Wi-Fi or other suitable type of network. In some embodiments, data communication between vehicle 10 and server 60 may be established via PED 41 serving as a hot spot, and in wired or wireless data communication with vehicle 10.

FIG. 6 shows vehicle 10 being at geographic location L1, which may be a region in proximity to house 82, when prompt 81 is issued. For example, when vehicle 10 is at geographic location L1, vehicle 10 may have access to a Wi-Fi network at house 82 or at a cottage of an owner of vehicle 10 where a connection to the internet may be suitable for performing an over-the-air software update.

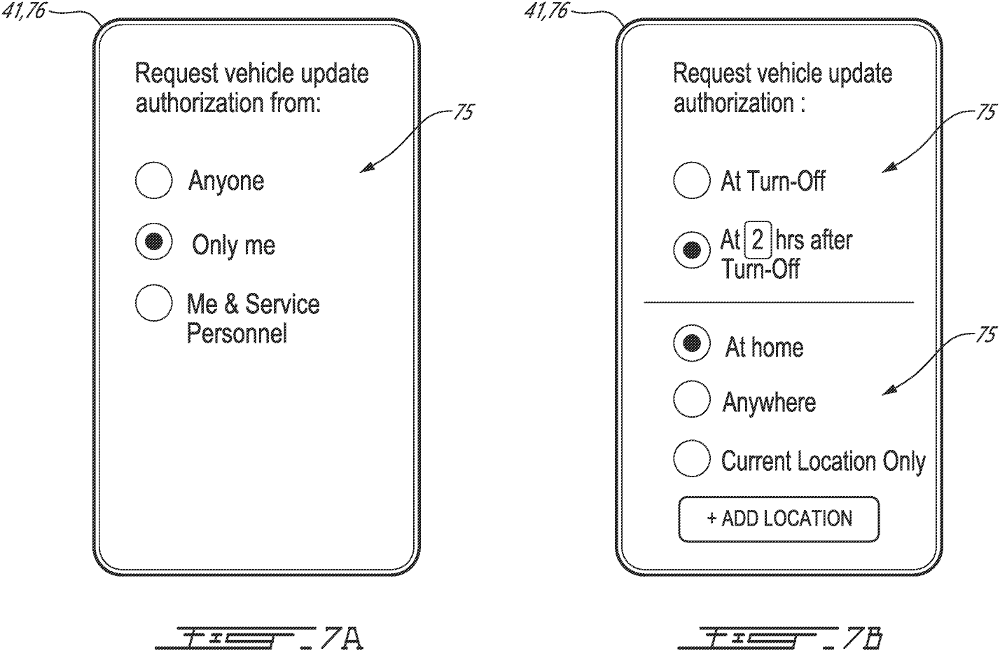

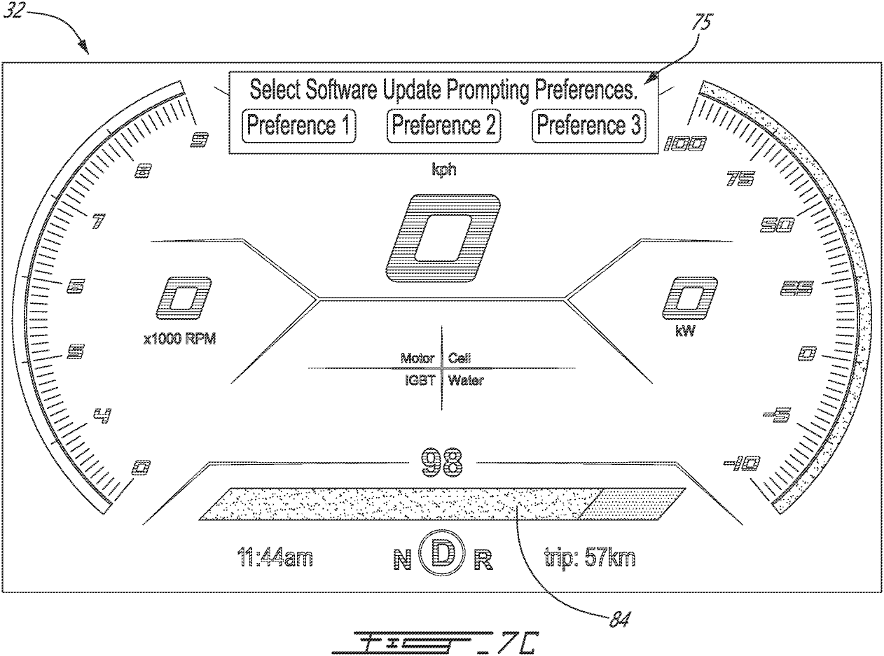

FIGS. 7A and 7B show examples of prompting preferences 75 being specified using a user interface separate from vehicle 10 provided via an app installed on PED 41 or on laptop computer 76 for example. Alternatively or in addition, prompting preferences 75 may be specified using onboard user interface 32 of vehicle 10 providing a suitable data entry interface such as those shown in FIGS. 7A and 7B. Prompting preferences 75 may be specified by the person of authority over vehicle 10 and then communicated to server 60 to be stored in the data table of FIG. 5 for example and used by server 60 to determine when prompt 81 should be issued. Alternatively or in addition, the specified prompting preferences 75 may be stored on vehicle 10 and used by controller 28 to determine when to issue prompt 81. FIG. 7A shows a prompting preference 75 specifying one or more prescribed vehicle operators being permitted to authorize software updates. As shown, the prescribed vehicle operators permitted to authorize software updates could include any operator of vehicle 10, only a selected person of authority over vehicle 10, or a combination of operators, such as a selected person of authority over the vehicle as well as service personnel. Additional vehicle operators who may be selected to authorize software updates could include a fleet operator, a fleet manager, manufacturer representatives, etc.

FIG. 7B shows the selection of a prompting preference 75 to wait 2 hours after turn-off to issue prompt 81. The specific amount of time to wait may be an editable field that can be adjusted by a user. Other options for time-based prompting preferences 75 may include a time of day, upon turning off the vehicle, or upon transitioning from an active state to an intermediate wake state. FIG. 7B also shows the selection of a prompting preference 75 specifying one or more geographic locations at which prompt 81 may be issued. In the example shown in FIG. 7B, the user interface may permit a selection from one or more previously saved geographic locations such as a vehicle owner’s home or a current location. The user interface may also permit the addition of a new location to be added as a selectable potential prescribed location. The addition of the new location may be done by the person of authority making a selection on a map displayed on PED 41 or on laptop computer 76, or by specifying GPS coordinates and/or boundaries of a geofence.

Prompting preferences 75 may include a threshold distance (e.g., radius) from a prescribed location at which prompt 81 may be issued for example. Prompting preferences 75 may include a condition of a specific communication network such as a home Wi-Fi network being detected by controller 28 of vehicle 10 for example. In some embodiments, the user interface may provide the ability for an address to be entered to specify a geographic location.

FIG. 7C shows an example of prompting preferences 75 being specified using onboard user interface 32 of vehicle 10 provided on an instrument panel of vehicle 10 for example. The prompting preferences “Preference 1”, “Preference 2” and “Preference 3” may be suggested vehicle operators, suggested time-based preferences and/or suggested location-based preferences. Prompting preferences 75 may be specified by the current operator of vehicle 10 and then communicated to server 60 to be stored in the data table of FIG. 5 for example and used by server 60 to determine when prompt 81 should be issued. Alternatively or in addition, the specified prompting preferences 75 may be stored on vehicle 10 and used by controller 28 to determine when to issue prompt 81. Onboard user interface 32 of vehicle 10 may also provide SoC indication 84 indicating of the SoC of battery 26 of vehicle 10.

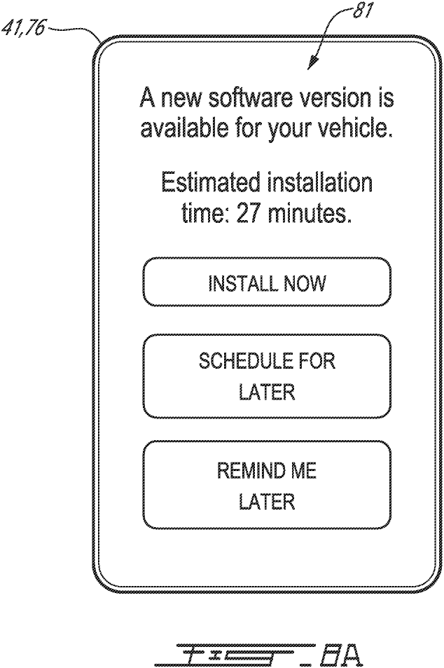

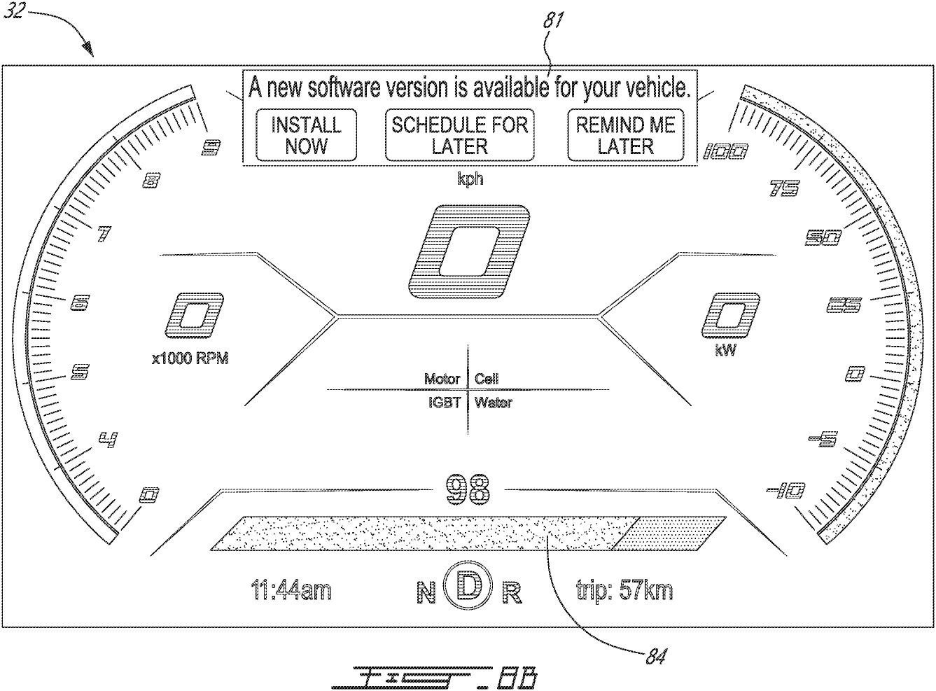

FIG. 8A shows an example of prompt 81 for requesting authorization to perform the software update on vehicle 10. The prompt 81 may be issued to an operator and/or to another person of authority in accordance with prompting preferences 75 associated with vehicle 10 or associated with a particular operator for example. Prompt 81 may be issued via onboard user interface 32, the app installed on PED 41 or on laptop computer 76 for example. Prompt 81 may inform the person of authority that new software version 66 is available for installation on vehicle 10 and may provide selectable options for managing the software update. In some embodiments, prompt 81 may also provide an estimated time required to complete the software update. One selectable option may facilitate the authorization to perform the software update now if the person of authority determines that it is appropriate to do so. Another selectable option may facilitate the authorization to perform the software update at a later time selected by the person of authority. Another selectable option may facilitate deferring the authorization of the software update by providing the option of being reminded of the software update later if a suitable time for performing the software update cannot be established at this time.

In some embodiments, the selectable option chosen may be communicated to server 60 so that the over-the-air download of new software version 66 may be initiated and the software update may be performed on vehicle 10 at the appropriate time. In situations, where new software version 66 has already been downloaded onto vehicle 10 when prompt 81 is issued, the selectable option chosen may be communicated to controller 28 onboard vehicle 10 to cause controller 28 of vehicle 10 to perform the software update at the appropriate time.

FIG. 8B shows another example of prompt 81 for requesting authorization to perform the software update on vehicle 10. Prompt 81 may be issued via onboard user interface 32 of vehicle 10 provided on an instrument panel of vehicle 10 for example. Prompt 81 provided on onboard user interface 32 may provide the same or other selectable options and functionality as described above in relation to FIG. 8A.

The above description is meant to be exemplary only, and one skilled in the relevant arts will recognize that changes may be made to the embodiments described without departing from the scope of the invention disclosed.

What is claimed is:

1. A method of performing a software update on a vehicle, the method comprising:
receiving a preference of a person of authority over the vehicle, the preference relating to issuing a request for an authorization to perform the software update on the vehicle;
determining that the software update is available for the vehicle;
issuing the request for the authorization to perform the software update on the vehicle in accordance with the preference of the person of authority over the vehicle;
receiving the authorization to perform the software update; and
initiating the software update on the vehicle after receiving the authorization to perform the software update.

2. The method as defined in claim 1, wherein the preference of the person of authority includes the request for the authorization to perform the software update on the vehicle to be issued only when the vehicle is located at one of one or more prescribed geographic locations.

3. The method as defined in claim 1, wherein the preference of the person of authority includes the request for the authorization to perform the software update on the vehicle to be issued only when the vehicle is operated by one of one or more prescribed operators.

4. The method as defined in claim 3, comprising:
receiving an identification of a current operator of the vehicle; and
determining that the current operator is one of the one or more prescribed operators.

5. The method as defined in claim 4, comprising receiving the identification of the current operator via near-field communication.

6. The method as defined in claim 1, wherein the preference of the person of authority is received via a portable electronic device separate from the vehicle.

7. The method as defined in claim 1, wherein the preference of the person of authority is received via a user interface of the vehicle.

8. The method as defined in claim 1, wherein the request for the authorization to perform the software update on the vehicle is issued via a or the portable electronic device separate from the vehicle.

9. The method as defined in claim 1, wherein the request for the authorization to perform the software update on the vehicle is issued via an or the user interface of the vehicle.

10. The method as defined in claim 1, wherein the preference of the person of authority includes the request for the authorization to perform the software update on the vehicle to be issued only after the vehicle has been in an off state for a prescribed amount of time of at least 30 seconds.

11. The method as defined in claim 1, wherein:
the vehicle is an electrically-propelled off-road vehicle; and
the initiation of the software update on the vehicle is conditioned upon a state of charge of a motoring battery of the vehicle being greater than a prescribed state of charge.

12. A computer program product for performing a software update on a vehicle, the computer program product comprising a non-transitory computer readable storage medium having program code embodied therewith, the program code readable/executable by a computer, processor or logic circuit to perform the method as defined in claim 1.

13. A system for performing a software update on a vehicle, the system comprising:
one or more data processors in data communication with a user interface; and
non-transitory machine-readable memory storing:
a preference of a person of authority over the vehicle for issuing a request for an authorization to perform the software update on the vehicle, the preference including:
the request for the authorization to perform the software update to be issued only when the vehicle is located at one of one or more prescribed geographic locations; and/or
the request for the authorization to perform the software update to be issued only when the vehicle is operated by one of one or more prescribed operators; and
instructions executable by the one or more data processors and configured to cause the one or more data processors to, when the software update is available for the vehicle:
cause the request for the authorization to perform the software update on the vehicle to be issued via the user interface in accordance with the preference of the person of authority; and
after receiving the authorization to perform the software update via the user interface, cause the software update to be performed on the vehicle.

14. The system as defined in claim 13, wherein the preference of the person of authority includes the request for the authorization to perform the software update on the vehicle to be issued only when the vehicle is located at one of one or more prescribed geographic locations.

15. The system as defined in claim 13, wherein the preference of the person of authority includes the request for the authorization to perform the software update on the vehicle to be issued only when the vehicle is operated by one of one or more prescribed operators.

16. The system as defined in claim 13, wherein the user interface includes a portable electronic device separate from the vehicle.

17. The system as defined in claim 13, wherein the user interface includes an instrument panel of the vehicle.

18. A computer-implemented method for installing a new software version on an electric off-road vehicle, the method comprising:
causing a request for an authorization to install the new software version on the electric off-road vehicle to be issued via a user interface in accordance with a preference of a person of authority over the electric off-road vehicle, the preference including:
the request for the authorization to install the new software version to be issued only when the electric off-road vehicle is located at one of one or more prescribed geographic locations; and/or
the request for the authorization to install the new software version to be issued only when the electric off-road vehicle is operated by one of one or more prescribed operators;
receiving the authorization to install the new software version; and
causing the new software version to be installed on the electric off-road vehicle after receiving the authorization to install the new software version.

19. The method as defined in claim 18, wherein the user interface includes a portable electronic device separate from the electric off-road vehicle.

20. The method as defined in claim 18, comprising causing the request for the authorization to install the new software version on the electric off-road vehicle to be issued only when a state of charge of a motoring battery of the electric off-road vehicle is greater than a prescribed state of charge.
